(19) United States
(12) Patent Application Publication
(10) Pub. No.: US 2013/0120430 A1
(43) Pub. Date: May 16, 2013

(54) ELECTRONIC DEVICE AND TEXT READING GUIDE METHOD THEREOF

(71) Applicants: HAI-SHENG LI, Shenzhen City (CN); YU-DA XU, Shenzhen City (CN); CHIH-SAN CHIANG, Tu-Cheng (TW); ZE-HUAN ZENG, Shenzhen City (CN)

(72) Inventors: HAI-SHENG LI, Shenzhen City (CN); YU-DA XU, Shenzhen City (CN); CHIH-SAN CHIANG, Tu-Cheng (TW); ZE-HUAN ZENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/441,008

(22) Filed: Apr. 6, 2012

(30) Foreign Application Priority Data
Nov. 16, 2011 (CN) 201110363220.7

(51) Int. Cl. G09G 5/02

(52) U.S. Cl. 345/589

(57) ABSTRACT

A text reading guide method for an electronic device including a display screen and a storage unit is provided. The storage unit stores a database recording a number of feature values of images and a plurality of coordinates. Each set of coordinates corresponds to a display region and is associated with a feature value. The method includes the steps of capturing an image of finger of a user; extracting a finger image feature value from the captured finger image; searching the database to find a matching finger image feature value, and retrieving the coordinates associated with the finger image feature value; determining the display content on the display region corresponding to the retrieved coordinates; and displaying the determined contents in a manner of highlighting on the display screen. An electronic device using the method is also provided.

### BACKGROUND

1. Technical Field

The present disclosure relates to an electronic device and a text reading guide method for the electronic device.

2. Description of Related Art

Many electronic devices, e.g., mobile phones, computers, and electronic readers (e-reader), are capable of storing and displaying electronic documents (e.g., digital images and digital texts). Users may manually control the displayed pages of an electronic document on these electronic devices to flip. However, many of the electronic documents include a number of pages, and usually the pages are displayed on the electronic device one at a time. Thus, the user should press the page flipping keys many times to flip through the pages, which is inconvenient especially when a large number of pages need to be displayed. Some of the electronic devices can automatically flip through the pages when the time flipping frequency has been preset by the user, but the then the page may be flipped before the user has finished reading each displayed page.

Therefore, what is needed is an electronic device and a text reading guide method thereof to alleviate the limitations described above.

### BRIEF DESCRIPTION OF THE DRAWINGS

The components in the drawings are not necessarily drawn to scale, the emphasis instead being placed upon clearly illustrating the principles of an electronic device and a text reading guide method for the electronic device. Moreover, in the drawings, like reference numerals designate corresponding sections throughout the several views.

FIG. 1 is a block diagram of an electronic device in accordance with an exemplary embodiment.

FIG. 2 is a posture feature database stored in the storage unit of the electronic device of FIG. 1.

FIG. 3 is a flowchart of a text reading guide method for electronic devices, such as the one of FIG. 1, in accordance with the exemplary embodiment.

FIG. 4 is a schematic diagram of the electronic device of FIG. 1, showing the user interface for the text reading guide, in accordance with an exemplary embodiment.

### DETAILED DESCRIPTION

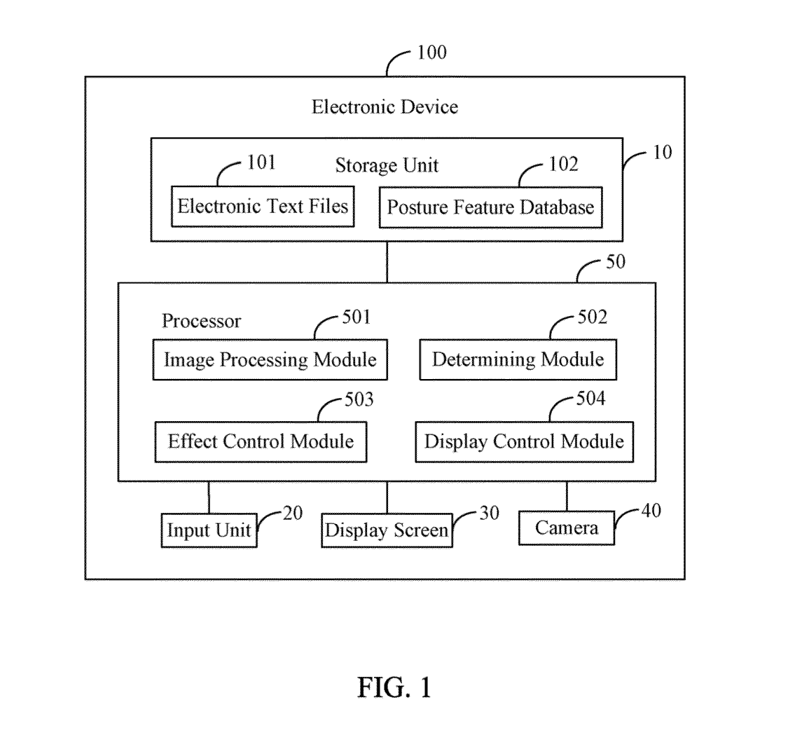

FIG. 1 is an exemplary embodiment of an electronic device 100. The electronic device 100 adjusts the text for reading according to the pointed direction of one or more fingers of the user. In the embodiment, the electronic device 100 is an electronic reader with a camera 40. In alternative embodiments, the electronic device 100 can be another electronic device with cameras, such as a mobile phone or a tablet, for example.

The electronic device 100 includes a storage unit 10, an input unit 20, a display screen 30, a camera 40, and a processor 50.

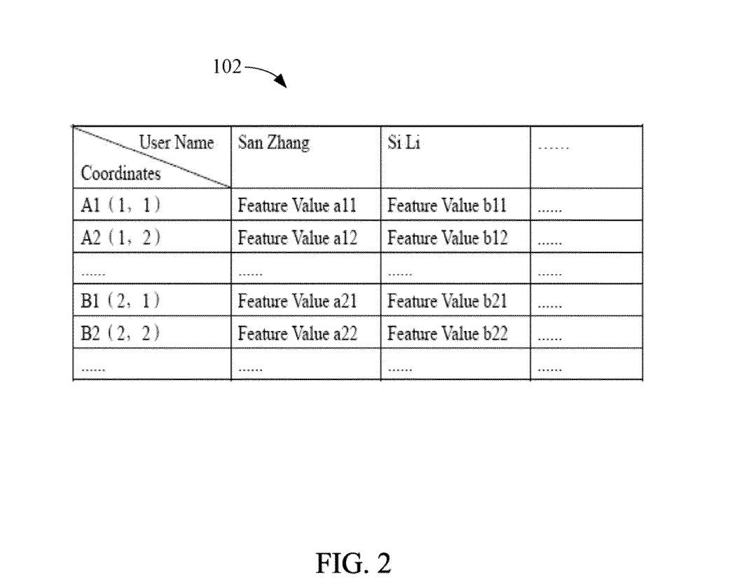

Together referring to FIG. 2, the storage unit 10 stores a plurality of electronic text files 101. The electronic text file 101 includes a text page. The storage unit 10 further stores a posture feature database 102 recording with at least one user's data and a number of coordinates of the display screen 30. Each user's data includes a user name, a number of feature values of images of one or more fingers of the user, and the relationship between each of a set of coordinates of the display screen 30 and each of the feature values of images of the one or more fingers of the user. In the embodiment, each of the coordinates corresponds to a display region of the display screen and is associated with a feature value. The number of feature values of images of the one or more fingers of the user corresponds to different parts of the display screen 30 to which one or more fingers of the user is pointing. The feature values of images of the one or more fingers of the user are different when the finger of the user points towards different coordinates on the screen 30. In an alternative embodiment, the posture feature database 102 further records a manner of highlighting predefined by the user. The manner of highlighting is selected from the group comprising the enlargement of the words, coloring of the words, underlining of the words, and displaying the words with a font different from the neighboring words, for example. In the embodiment, the manner of highlighting is different from the default displaying style of the display screen 30, to produce a marking effect on words and distinguish the words from other words not marked. The data in the posture feature database 102 is gathered via a navigation interface when the electronic device 100 is powered on and the adjustment of text for reading function of the electronic device 100 is activated, which will be explained later in this specification.

The input unit 20 receives user commands and selections. The user selections may include activating, executing and ending the adjustment of text for reading function of the electronic device 100, and setting the adjustment of text for reading function, for example.

The camera 40 captures images of one or more fingers of a user in real-time and transmits the images of the one or more fingers to the processor 50. In the embodiment, the camera 40 is secured on the middle top of the display screen 30 for the purpose of capturing images of the one or more fingers of the user, and the camera 40 is activated as long as the adjustment of text for reading function of the electronic device 100 is activated. In alternative embodiments, the camera 40 is secured on the middle left or other portions of the display screen 30.

The processor 50 includes an image processing module 501, a determining module 502, an effect control module 503, and a display control module 504.

The image processing module 501 analyzes and processes the images of the one or more fingers by running a variety of image processing algorithms, thus extracting the image feature values of the one or more fingers from the captured images of the one or more fingers of the user.

The determining module 502 searches the posture feature database 102 to find the image feature value of the one or more fingers of the user which may match with the extracted image feature value of the one or more fingers of the user. The determining module 502 is further configured to retrieve the screen coordinates associated with the image feature value of the one or more fingers of the user recorded in the posture feature database 102, and to transmit the retrieved coordinates to the effect control module 503.

The effect control module 503 determines the display content such as single words, phrases or complete sentences on the display region corresponding to the retrieved coordinates on the display screen 30, according to the type of effects predefined by the user or the system of the electronic device 100. For example, the marking of words may be by zooming, coloring, or underlining the display content on the display region, for example.

The display control module 504 displays the determined contents in a manner of highlighting on the display screen 30.

In use, when a user activates the adjustment of text for reading function of the electronic device 100 via the input unit 20, the display control module 504 controls the display screen 30 to display an information input box for the user to input a user name. The determining module 502 determines whether the posture feature database 102 records the user name and other data for that username. If the posture feature database 102 records the user name and corresponding data, the image processing module 501, the determining module 502, the effect control module 503, and the display control module 504 cooperate together to execute the adjustment of text for reading function.

When the determining module 502 determines that the user name and the corresponding data do not exist in the posture feature database 102, that means it is the first time for the user to use the adjustment of text for reading function of the electronic device 100. The display control module 504 controls the display screen 30 to display a dialog box inviting the user to do a test for recording finger image feature values of his/her finger images. If the user determines to do the test, the display control module 504 further controls the display screen 30 to display the test page of the electronic text file 101. In the embodiment, the content of the test page includes a number of different portions. The display screen 30 defines a coordinate system. Each portion of the test page is displayed on a particular display region with coordinates associated therewith. The display control module 504 also controls the display screen 30 to display a dialog box prompting the user to follow the highlighted contents.

In the embodiment, each portion of the test page corresponds (is located on) to particular coordinates of the display screen 30. The camera 40 captures finger images of the user when the finger of the user points toward any portion, and transmits the finger image to the image processing module 501. The image processing module 501 is further configured to extract the finger feature values of the image of the finger of the user, and to store the extracted finger feature values corresponding to the user name and the coordinates of the portion of the display screen 30 to which the finger was pointing, in the posture feature database 102. When all portions of the text have been read, the test is completed, then the user can activate the adjustment of text for reading function of the electronic device 100.

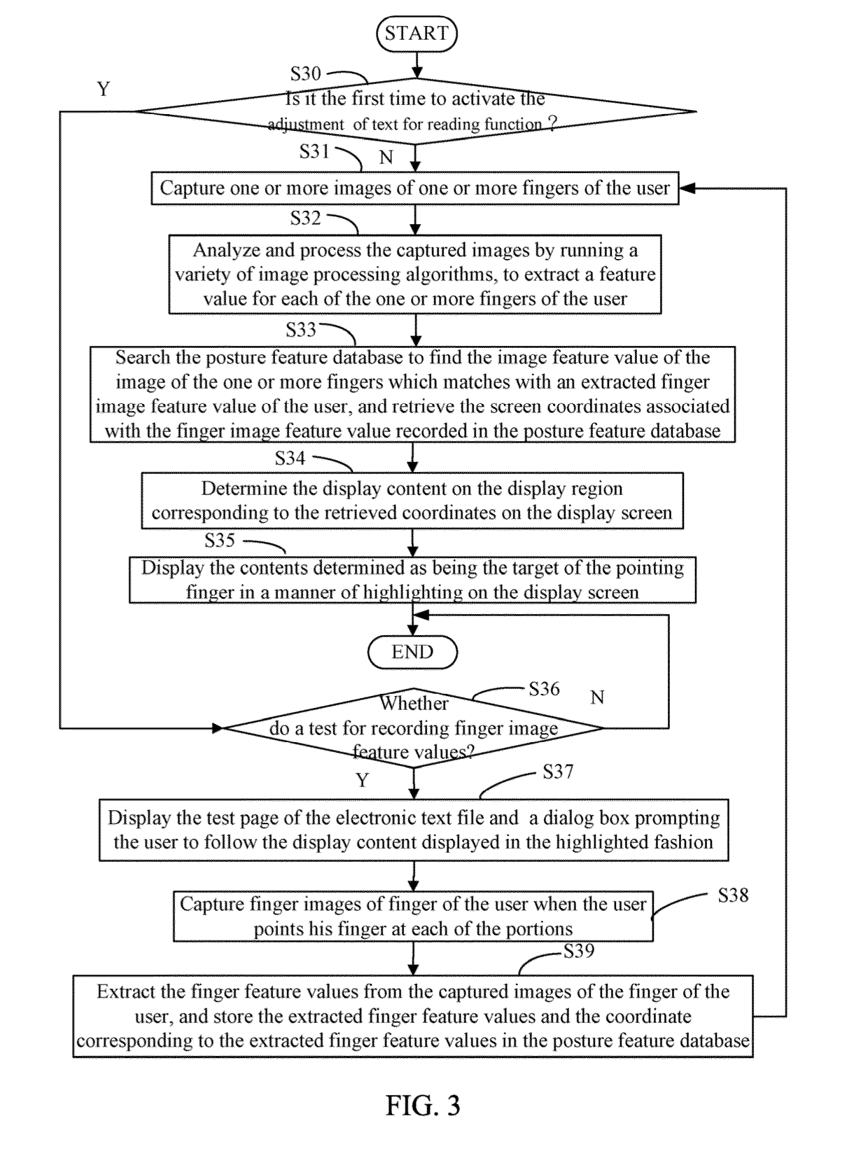

Referring to FIG. 3, a flowchart of a text reading guide method of the electronic device 100 of FIG. 1 is shown. The method includes the following steps.

In step S30, a user activates the adjustment of text for reading function of the electronic device 100, the determining module 502 determines whether it is the first time for the user to activate the adjustment of text for reading function. If no, the process goes to step S31, if yes, the process goes to step S36. In this embodiment, if the user name input by the user exists in the posture feature database 102, the determining module 502 determines it is not the first time for the user to activate the adjustment of text for reading function. Otherwise, the determining module 502 will determine it is the first time for the user to activate the adjustment of text for reading function. In the embodiment, the camera 40 is activated when the user activates the adjustment of text for reading function.

In step S31, the camera 40 captures one or more images of one or more fingers of the user.

In step S32, the image processing module 501 analyzes and processes the captured images by running a variety of image processing algorithms, to extract a feature value for each image of the one or more fingers of the user.

In step S33, the determining module 502 searches the posture feature database 102 to find the feature value of the image of the one or more fingers which matches with an extracted finger image feature value of the user, and retrieves the screen coordinates associated with the finger image feature value recorded in the posture feature database 102. In an alternative embodiment, the determining module 502 searches the posture feature database 102 to find an finger image feature value with a highest percentage similarity to an extracted finger image feature value of the user, and then retrieves the screen coordinates associated with the finger image feature value recorded in the posture feature database 102, when the exact finger image feature value of the user is not found in the database.

In step S34, the effect control module 503 determines the display content such as single words, phrases, or complete sentences on the display region corresponding to the retrieved coordinates on the display screen 30, according to a predefined type of text reading guide effect.

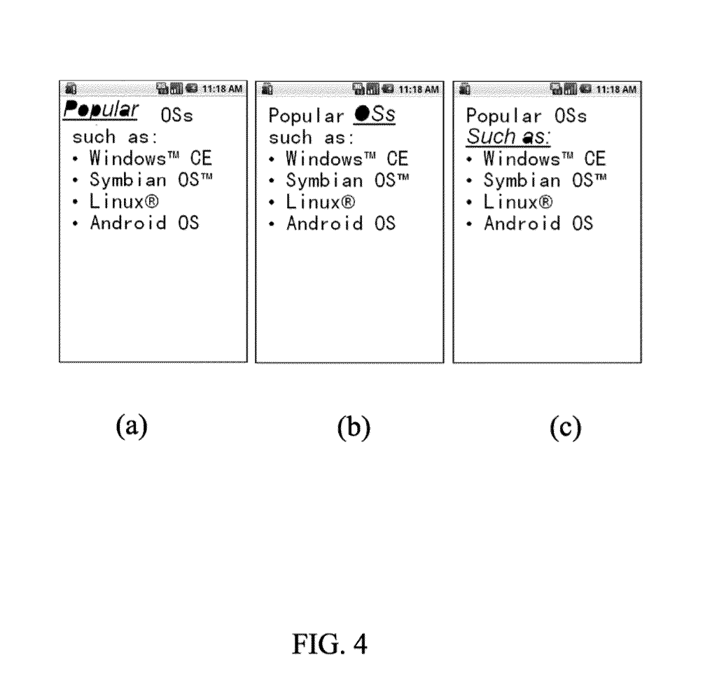

In step S35, the display control module 504 displays the contents determined as being the target of the pointing finger in a manner of highlighting on the display screen 30 in place of the originally-displayed content. Referring to FIG. 4, the figures (a)-(c) each show different formats of different parts of the same text. The image feature values of images of the finger of the user corresponding to three coordinates are extracted, and the display content corresponding to the coordinates are marked. That is, the display content—“Popular”, “OSs”, and “Such as” are respectively underlined, displayed in italics, and filled with black in the enclosed areas.

In step S36, if it is the first time for the user to activate the adjustment of text for reading function, the determining module 502 invites the user to do a test for recording finger image feature values of his/her finger images, if yes, the process goes to step S37, otherwise, the process ends.

In step S37, the display control module 504 controls the display screen 30 to display the test page of the electronic text file 101, and controls the display screen 30 to display a dialog box prompting the user to follow the content displayed in the highlighted fashion to read. In the embodiment, the content of the test page includes a number of different portions, and each different portion of the test page is displayed on a display region with coordinates associated therewith.

In step S38, the camera 40 captures images of the finger of the user when the user points his finger at each of the portions to be read.

In step S39, the image processing module 501 extracts the finger feature values from the captured images of the finger of the user, and stores the extracted finger feature values and the coordinates corresponding to the extracted finger feature values in the posture feature database 102.

With such a configuration, when the adjustment of text for reading function of the electronic device 100 is activated, the display content corresponding to the coordinates of the display screen 30 being pointed at by the user are executed special treatment and then displayed to the user. Thus, a vivid content displaying effect is presented to the user of the electronic device 100 when the user is reading the display screen 30, which makes viewing and reading more expedient and convenient.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A text reading guide method for an electronic device, the electronic device comprising a display screen and a storage unit storing a database and an electronic text file, the database recording a plurality of feature values of images of one or more fingers of a user, and a plurality of coordinates each corresponding to a display region of the display screen and being associated a corresponding feature value, the method comprising:
capturing a real-time image of one or more fingers of a user;
extracting an image feature value from the captured image of the one or more fingers;
searching the database to find the image feature value of the user matching with the extracted image feature value of the one or more fingers of the user, and retrieving the coordinates associated with the image feature value of the finger recorded in the database;
determining the display content on the display region corresponding to the retrieved coordinates; and
displaying the determined contents in a manner of highlighting on the display screen.

2. The method as described in claim 1, further comprising:
searching the database to find an image feature value of the finger with a highest percentage similarity to the extracted image feature value of the finger of the user, and retrieving the coordinates associated with the image feature value of the finger recorded in the database, when the image feature value of the one or more fingers of the user matching with the extracted image feature value of the one or more fingers of the user is not found in the database.

3. The method as described in claim 1, wherein the manner of highlighting is selected from the group consisting of enlarging the display content, coloring the display content, underlining the display content, and displaying the display content with a font different from the content in neighboring region.

4. The method as described in claim 1, further comprising:
displaying a test page of the electronic text file on the display screen, the content of the test page comprising a plurality of different portions, the display screen defining a coordinate system, each portion of the test page being displayed on a corresponding display region with coordinates associated therewith;
capturing images of the one or more fingers of the user when the user focuses on each of the portions; and
extracting the finger feature values from the captured images of the one or more fingers of the user, and storing the extracted finger feature values and the coordinate corresponding to the respective extracted finger feature values in the database.

5. The method as described in claim 4, further comprising displaying a dialog box on the display screen prompting the user to follow the display content displayed in the highlighted fashion.

6. The method as described in claim 4, wherein the manner of highlighting is selected from the group consisting of enlarging the display content, coloring the display content, underlining the display content, and displaying the display content with a font different from the content in neighboring region.

7. An electronic device, comprising:
a display screen;
a storage unit storing a database and an electronic text file, the database recording at least one user's data and a plurality of coordinates, each user's data comprising a user name, a plurality of feature values of images of one or more fingers of the user, and a plurality of coordinates each corresponding to a display region of the display screen and being associated a corresponding feature value;
a camera configured to capture a real-time image of one or more fingers of the user;
an image processing module configured to extract an image feature value from the captured image of the one or more fingers;
an determining module configured to search the database to find the image feature value of the one or more fingers of the user matching with the extracted image feature value of the one or more fingers of the user, and to retrieve the coordinates associated with the image feature value of the finger recorded in the database;
an effect control module configured to determine the display content on the display region corresponding to the retrieved coordinates; and
a display control module configured to control the display screen to display the determined contents in a manner of highlighting.

8. The electronic device as described in claim 7, wherein the determining module is further configured to search the database to find an image feature value of the finger with a highest percentage similarity to the extracted image feature value of the one or more fingers of the user, and to retrieve the coordinates associated with the image feature value recorded in the database, if the image feature value of the one or more fingers of the user matching with the extracted image feature value of the one or more fingers of the user is not found in the database.

9. The electronic device as described in claim 7, wherein:
the determining module is further configure to determine whether the user agree to do a test for recording image feature values of his/her finger's images; and
the effect control module is further configured to display a test page of the electronic text file on the display screen, the content of the test page comprising a plurality of different portions, the display screen defining a coordinate system, each portion of the test page being displayed on a corresponding display region with coordinates associated therewith;
the camera is further configure to capture images of one or more fingers of the user when the user focuses on each of the portions; and
the image processing unit is further configured to extract the finger feature values from the captured images of the one or more fingers of the user, and to store the extracted finger feature values and the coordinate corresponding to the respective extracted finger feature values in the database.

10. The electronic device as described in claim 9, wherein the effect control module is further configured to display a dialog box on the display screen prompting the user to follow the display content displayed in the highlighted fashion.

11. The electronic device as described in claim 9, wherein the manner of highlighting is selected from the group consisting of enlarging the display content, coloring the display content, underlining the display content, and displaying the display content with a font different from the content in neighboring region.

12. The electronic device as described in claim 7, wherein the manner of highlighting is selected from the group consisting of enlarging the display content, coloring the display content, underlining the display content, and displaying the display content with a font different from the content in neighboring region.

13. The electronic device as described in claim 7, being an electronic reader.
